(19) United States
(12) Patent Application Publication
(10) Pub. No.: US 2006/0251018 A1
(43) Pub. Date: Nov. 9, 2006

(54) Method and device for intermediate storage of subscriber data during a relocation of a mobile subscriber within a mobile communication network

(75) Inventors: Sandra-Agata Borcic, Zagreb (HR); Richard Branco, Strasshof (AT); Herbert Paulis, Wien (AT)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/555,666

(22) PCT Filed: Apr. 27, 2004
(86) PCT No.: PCT/EP04/50613

§ 371 Date: Nov. 4, 2005

(30) Foreign Application Priority Data
May 5, 2003 (DE) 103 19 982.9

(51) Int. Cl. H04Q 7/00

(52) U.S. Cl. 370/331; 455/433

(57) ABSTRACT

The invention relates to a method and a device for the intermediate storage of subscriber data during the relocation of a mobile subscriber (MS) within a mobile communication network. According to the invention, once the data transmission path has moved from a switching network node (old SGSN), which is originally responsible for the subscriber, to a switching network node (new SGSN), which is to become responsible for the subscriber, the data packets are intermediately stored in the last switching network node until the subscriber data for the new data transmission path is located in the last switching network node.

The invention relates to a method and a device for intermediate storage of subscriber data during a relocation of a mobile subscriber within a mobile communication network.

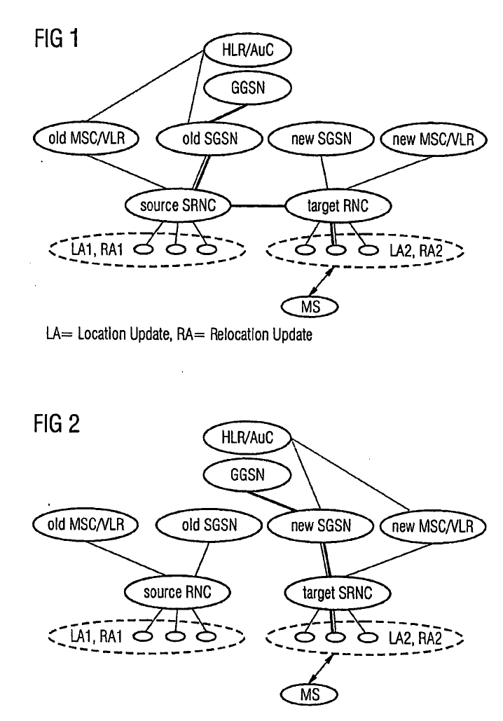

In the course of a relocation of a UMTS/GPRS mobile radio subscriber in some case the packet switch routing the traffic (SGSN=Serving GPRS Support Node) has to be changed. The extract from the Standard (3GPP TS 23.060) shown schematically in FIG. 1 presents the situation schematically.

FIG. 1 shows the forwarding of subscriber data (user data routing), if the Serving Radio Network Controller (SRNC=) and the Target Radio Network Controller (TRNC=) are connected to different network nodes (SGSN=Serving GPRS Support Node) which support the GPRS (General Packet Radio Service) before a relocation (SRNS=Serving Radio Network Subsystem Relocation) takes place. FIG. 2 shows the forwarding of subscriber data after the procedure “SRNS Relocation” and when the procedure “Routing Area Update” is ended. In the case shown the mobile station (MS) is in the status “PMM-CONNECTED”.

Before the procedure “SRNS Relocation” and “Routing Area Update” the mobile station is registered at the “old” SGSN. The origin RNC operates as serving RNC. After the procedures “SRNS Relocation” and “Routing Area Update” (RA=Routing Area)—as indicated in FIG. 2—the mobile station is registered at the “new” SGSN. The mobile station is in the status “PMM-CONNECTED” in relation to the new SGSN and the destination RNC operates as serving RNC.

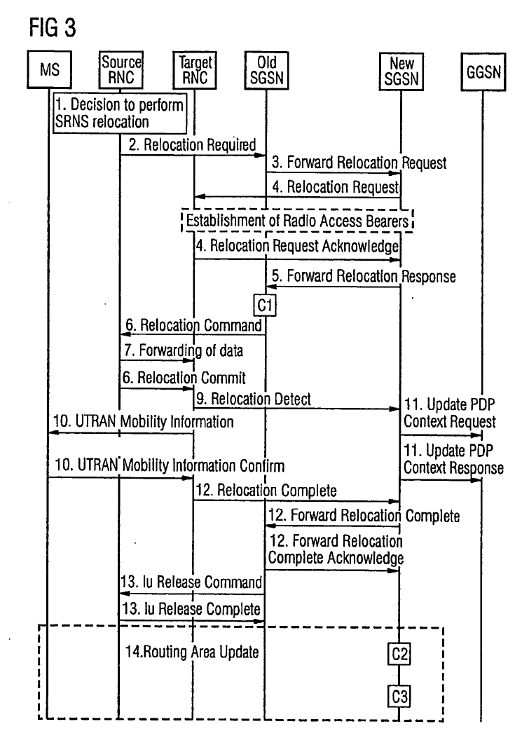

In this case there is a “hole”, in which data is already being transmitted over the new connection (Message 7 in FIG. 3), although the subscriber is not yet known there. In itself this is no problem for the data transmission and is of no significance, for Lawful Interception (LI) however it produces a problem since it can only be decided when the subscriber data has been completely transmitted (message block 14 in FIG. 3) whether the subscriber is to be subject to surveillance or not. However in previous methods data had already been transmitted which is then lost for surveillance.

The object of the invention is to overcome the disadvantages described above.

The object is achieved by the features of a method and a network node in accordance with the independent patent claims. Advantageous developments of the invention are identified in further independent patent claims.

An important aspect of the invention comprises method for intermediate storage of data packets during a relocation of a mobile subscriber within a communication network, with the data packets, once the data transmission path has moved from a switching network node originally responsible for the subscriber to a switching network node which is to become responsible for the subscriber are stored in the last switching network node until the subscriber data provided for the new data transmission path is located in the last switching network node.

A further aspect of the invention consists of the embodiment of a network node suitable for intermediate storage of data packets during a relocation of a mobile subscriber within a communication network featuring means for intermediate storage of data packets after the data transmission path changes from a switching network node originally responsible for the subscriber to the said network node, until such time as the subscriber data provided for the new data transmission path is available.

Further details of the invention are explained on the basis of an exemplary embodiment with reference to a drawing. The Figures show:

FIG. 1—as described above—a schematic network layout for routing subscriber data,

FIG. 2—as described at the start—a schematic network arrangement after the end of the relocation procedure and

FIG. 3 a message flow diagram for the above-mentioned relocation procedure.

FIGS. 1, 2 described at the beginning of this document are schematic diagrams of network arrangements with interlinked network elements HLR/AuC, GGSN, old MSC/VLR, old SGSN, new SGSN, new MSC/VLR: source (S)RNC, target (S)RNC, MS (mobile station), LA1 (LA2=Location Update), LA2 RA1 (RA=Relocation Update), RA2. The reference symbol correspond to the abbreviations for mobile radio network elements normally used in mobile radio technology. The broader lines show the connection from the mobile stations MS through the communication network. These same reference symbols/abbreviations are used in FIG. 3. The message transmitted between the network elements are identified by numbers and abbreviations which are fixed expressions normally used in conjunction with mobile radio networks.

In FIG. 3 the solution now makes provision, in an earlier phase of each relocation procedure to introduce at the new SGSN a buffering or intermediate storage of packets, regardless of whether the relevant subscriber is subject to surveillance or not, since this information is not yet available. Possible trigger points for the buffering of the data would be the messages “Forward Relocation Request” (3), “Relocation Request Acknowledge” (4) and “Relocation Detect” (9). The message actually used to trigger the buffering depends on the implementation, however the ready-to-store state should be established as early as possible.

The information as to whether surveillance is actually to be undertaken is not available until the end of the relocation procedure within the following RAU procedure (14) (RAU=Relocation Area Update) if the user data was transmitted. Up until that point all packets are buffered. If the subscriber is to be subject to surveillance his packets are not lost and can be further evaluated. If he is not to be subjected to surveillance, the packets are discarded. (after message block 14 in FIG. 3) the average duration of the process amounts to appr. 5700 ms, for safety reasons the solution has been dimensioned so that a buffer time of 15 is retained to ensure that no data is lost even with delays.

What is claimed is:

1. A method for intermediate storage of data packets during a relocation of a mobile subscriber within a communication network, comprising:
once a data transmission path has moved from a switching network node originally responsible for the mobile subscriber to a switching network node which is to become responsible for the mobile subscriber, in a previous switching network node until the subscriber data provided for a new data transmission path is located in the last switching network node.

2. The method according to claim 1, wherein the intermediate storage of the data packets is initiated independently of whether the subscriber is to be monitored.

3. The method according to claim 1, wherein, for the intermediate storage of the data packets, trigger points are introduced with aid of messages including at least one of a “Forward Relocation Request”, “Relocation Request Acknowledge” or “Relocation Detect”.

4. The method in accordance with claim 1, wherein, after transmission of the moboile subscriber data, buffered data packets are deleted if the mobile subscriber is not to be monitored.

5. A network node for intermediate storage of data packets during a relocation of a mobile subscriber within a communication network, comprising:
a storage device for intermediate storage of data packets after a transmission path has moved from a switching network node originally responsible for the mobile subscriber to become responsible for the network node until the mobile subscriber data provided for a new data transmission path is available.
